(19) United States
(12) Patent Application Publication
(10) Pub. No.: US 2014/0308500 A1
(43) Pub. Date: Oct. 16, 2014

(54) MINERAL FILLED POLYMER COMPOUNDS FOR THE PRODUCTION OF FLEXIBLE PLASTIC FILM AND SHEET SUBSTRATES WITH IMPROVED YIELD

(71) Applicant: HERITAGE PLASTICS, INC., PICAYUNE, MS (US)

(72) Inventor: FRANK A. RUIZ, FLOWER MOUND, TX (US)

(73) Assignee: HERITAGE PLASTICS, INC., PICAYUNE, MS (US)

(21) Appl. No.: 14/244,530

(22) Filed: Apr. 3, 2014

Related U.S. Application Data
(60) Provisional application No. 61/811,170, filed on Apr. 12, 2013.

(51) Int. Cl. C08K 3/26; B29C 44/22

(52) U.S. Cl. CPC C08K 3/26; B29C 44/22; C08K 2003/265
USPC 428/220; 264/45.3; 524/425; 523/122

(57) ABSTRACT

A flexible plastic sheet made from a mineral/polymer compound mixture. The mineral/polymer compound mixture including a mineral component comprising 25%-75% by weight of the mixture and a polymer component comprising 75%-25% by weight of the mixture. The flexible plastic sheet defines a micro porous closed cell structure including a plurality of microscopic voids created during a simultaneous cooling and cavitation inducing process to produce the flexible plastic sheet.

### CROSS-REFERENCE TO RELATED APPLICATIONS

This application claims benefit of U.S. Provisional Application No. 61/811,170, filed Apr. 12, 2013, entitled MINERAL FILLED POLYMER COMPOUNDS FOR THE PRODUCTION OF FLEXIBLE PLASTIC FILM AND SHEET SUBSTRATES WITH IMPROVED YIELD (Atty. Dkt. No. HPLA-31553), which is herein incorporated by reference in its entirety.

### TECHNICAL FIELD

The present invention relates to the manufacture of mineral filled polymer compounds, and more particularly, to the use of simultaneous cooling and applying extensional sheer forces during manufacture of a mineral filled polymer sheet to reduce density within the mineral filled polymer compound sheet.

### BACKGROUND

Minerals have been utilized to reinforce and reduce the cost of polymers since the commercialization of polymers. Mineral addition can improve stiffness, impact strength, heat resistance, wear resistance, chemical resistance and other important end use characteristics of the base polymer.

Minerals often are added to reduce cost, as the mineral is usually much less expensive on a weight basis than the polymer being replaced. This is why a large proportion of higher cost engineering polymers, such as polyamide or poly-butylene-terephthalate, contain mineral or other inorganic reinforcements.

Mineral additions to polymers in many cases reduce the energy required for processing, as the minerals improve heat conductivity of the molten compound. This improves the thermal efficiency of heating and cooling conducted during polymer processing.

Minerals often have a lower manufacturing environmental footprint than petroleum-based polymers, and mineral additions can affect a significant reduction in the amount of greenhouse gases and other atmospheric pollutants in the end product life cycle analysis.

However, when minerals are added to polymers, the density of the mixture will increase. This increase in density of the polymer/mineral blend causes an increase in the weight per unit volume of a molded article, or the weight per unit area of a film or sheet. The weight per unit area of a film or sheet is commonly known as the basis weight, and is commonly expressed in grams per square meter [g/m², or gsm]. With increasing density there is a need to increase the basis weight to maintain a constant film or sheet thickness. Mineral additions to lower cost commodity polymers, such as polyethylene, can require an increase in basis weight that can offset the economic benefits observed in compound cost per unit of weight. Thus, there is a need for a system and method of manufacture of mineral/polymer compounds that provides the benefit of the use of increased minerals while limiting the concurrent increase in weight of the mineral/polymer blend.

### SUMMARY

The present invention as disclosed and described herein, in one aspect thereof, comprises a flexible plastic sheet made from a mineral/polymer compound mixture. The mineral/polymer compound mixture includes a mineral component comprising 25%-75% by weight of the mixture and a polymer component comprising 75%-25% by weight of the mixture. The flexible plastic sheet defines a micro porous closed cell structure including a plurality of microscopic voids created during a simultaneous cooling and cavitation inducing process to produce the flexible plastic sheet.

### BRIEF DESCRIPTION OF THE DRAWINGS

For a more complete understanding, reference is now made to the following description taken in conjunction with the accompanying Drawings in which:

FIG. 1 is a flow diagram describing the manner for producing mineral/polymer composite pellets;

FIG. 2 is a flow diagram describing the method for processing the mineral/polymer composite pellets to produce an improved mineral/polymer composite sheet; and

FIG. 3 illustrates one example of an apparatus for producing the mineral/polymer composite sheet according to the process described herein.

### DETAILED DESCRIPTION

Referring now to the drawings, wherein like reference numbers are used herein to designate like elements throughout, the various views and embodiments of a system and method for producing mineral filled polymer compounds are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

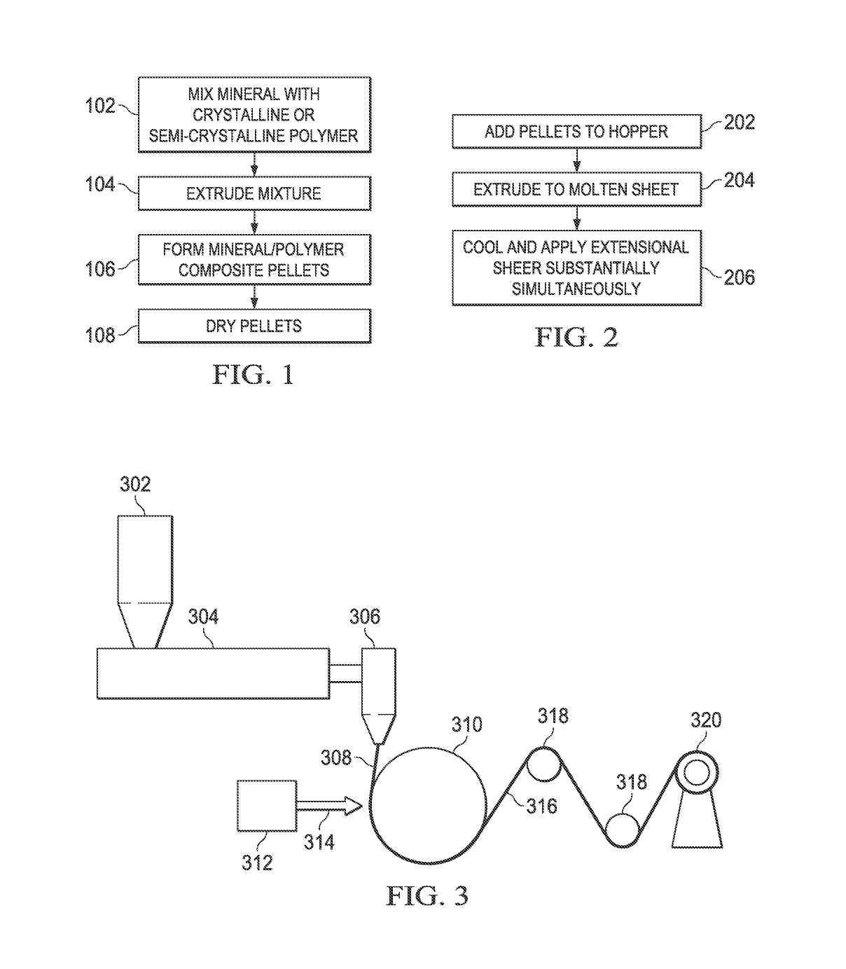

Referring now to the drawings, and more particularly to FIGS. 1-3, the process described herein improves the economics of mineral addition to polymers by describing the creation of compounds that when processed in a selected manner develops microscopic voids within the polymer matrix. This process of developing microscopic voids within an article, film or sheet is known as cavitation. These microscopic voids reduce the density of the film or sheet extruded from the mineral/polymer blend while increasing the area attained of the film or sheet at a given thickness and a given weight of raw material.

Previous implementations of mineral/polymer blends have utilized a toughening mechanism in semi-crystalline polymer blends using calcium carbonate filler particles. This process added high levels (25% by volume) of calcium carbonate to high-density polyethylene by producing melt blended compounds and injection molding. The process provided a 15-fold increase in impact strength with certain grades of calcium carbonate, but only at the gate end of the molded part, where the melt sheer or flow rate is the highest. In studying the structure of these polymer/mineral composites, it was learned that the calcium carbonate had modified the crystalline structure of the solid polyethylene, dramatically changing its properties.

Thus, as more particularly illustrated in FIG. 1, the initial process involves the creation of a mixture of the compound by mixing a mineral with a crystalline or semi-crystalline polymer at step 102. The percentages of mineral proportion of the mixture may range from 25 percent to 75 percent, and the associated percentage by weight of the polymers may range from 75 percent to 25 percent of the crystalline or semi-crystalline polymer. The mixture is extruded at step 104 and formed into a mineral/polymer composite of pellets at step 106. The various minerals and crystalline or semi-crystalline polymers which may be utilized within the mixture may vary. The mineral may comprise, for example, calcium carbonate, wherein the calcium carbonate has a surface area of less than 4.0 m²/g or wherein the calcium carbonate has a main particle size of between 2 to 6 microns. Additionally, the calcium carbonate can have a top size of less than 25 microns. In some embodiments, the calcium carbonate may also be surface treated with stearic acid prior to combination with the polymer.

The crystalline or semi-crystalline polymer may comprise in one embodiment polylactic acid or poly-lactide. The polylactic acid may have a melt index of 2.0 to 4.0 and a density of 1.25 g/cm³. The combination of mineral and polymer compound may then be dried at step 108 prior to extrusion.

In addition to the mineral/polymer material, the compound may also include one or more moisture scavenging ingredients. The composition may also include one or more other polymers such as poly-butylene-adipate/terephthalate, poly-butylene-succinate, poly-butylene-succinate/adipate or polyhydroxyalkanoate (PHA). Additives such as color pigments, anti-static agents, biocides, odorants or photosensitizers may also be added to the mixture at step 102 prior to extrusion.

Functional additives such as peroxide or coupling agents may also be added as a method of increasing polymer molecular weight. The compound may also contain polyesters such as poly-butylene-adipate-terephthalate, poly-butylene-succinate, poly-butylene-succinate-adipate, polyhydroxyalkanoate or its co-polymers, or polycaprolactone.

Referring now to FIG. 2, once the mineral/polymer compound has been created, the pellets may be added into a mechanism such as that illustrated in FIG. 3. The mineral/polymer compound pellets are added at step 202 into a hopper 302. Next, at step 204, the pellets are extruded into a molten sheet using an extruder 304 and a wide slot die 306. From the output of the wide slot die 306, the molten composite 308 is deposited onto the surface of a cold chill roll 310. The cold chill roller 310 cools and solidifies the molten compound 308. The molten compound 308 is forced onto the cold chill roll 310 via an air knife 312 which uses an airstream 314 to force the molten compound 308 onto the surface of the cold chill roll 310.

In addition to cooling the molten compound 308 into a solidified composite 316, extensional sheer forces are applied to the cooling mineral polymer compound such that the cooling and sheer forces are substantially simultaneously applied to the mineral/polymer compound at step 206. The extensional sheer forces are applied using a series of tension control rollers 318 and a winder 320. The winder 320 pulls the solidified composite 316 off the chill roller 310 while the tension control rolls cause the extensional sheer forces to be applied to the material.

The extensional sheer forces applied to the mineral/polymer compound acts as a powerful nucleating agent. Adding 40 to 50 percent mineral to the semi-crystalline or crystalline polymer raises the crystallization temperature of the polymer in the blown film process from 52 degrees C. to 87 degrees C. By simultaneously cooling and subjecting the polymer to extensional (instead of flow) sheer, the nucleating effect of the mineral causes a rapid unconstrained crystallization of the polymer. Continual extensional sheer forces prevents the polymer crystal structure from packing into a tight matrix leaving microscopic voids within the film. This provides a dendritic crystal structure within the film having a remarkable physical strength given the amount of mineral present within the extruded film.

Next, a discussion of some examples of mineral/polymer compounds prepared according to the description here and above will be provided.

### Example 1

Poly-lactic acid with a melt flow of 3.0 is mixed with an equal amount of calcium carbonate with a medium particle size of 5 microns. The blend is melted, mixed and extruded into a molten compound on a continuous mixer and extruded and formed into pellets of a mineral/polymer composite, hereinafter referred to as the composite.

The composite pellets are processed on an apparatus as illustrated in FIG. 3. The pellets are added to a hopper 302 of a single screw, 1-inch diameter extruder 304 fitted with an 8-inch wide slot die 306. The molten composite 308 is cast onto an 18-inch wide, 10-inch diameter, chrome-plated, polished, cooled chill roll 310. The molten curtain is pressed into contact with the chill roll 310 by impingement of an essentially perpendicular stream of air 314 from an air knife 312. The solidified composite 316 is continuously pulled away from the chill roll 310 over several tension control rollers 318 by a winder 320 which maintains tension on the web and draws the molten composite down to the desired thickness.

The composite pellets were processed under the conditions detailed in Table 1.

TABLE 1
Cast Film Trial of calcium carbonate/poly-lactide composition

| Extruder | Melt | | Line | Film | Calculated Basis | Calculated Basis | | Film |
|---|---|---|---|---|---|---|---|---|
| Screw Speed, | Temp | Chill roll | Speed | thickness | wt at 1.0 g/cm³, | wt at 1.71 g/cm³, | Actual basis | Density, |
| RPM | (F.) | temp (F.) | (fpm) | (microns) | g/m² | g/m² | weight, g/m² | g/cm³ |
| 40 | 320 | 180 | 20 | 66 | 66 | 112 | 56 | 0.90 |
| 40 | 320 | 180 | 30 | 58 | 58 | 99 | 51 | 0.89 |
| 40 | 320 | 180 | 40 | 57 | 57 | 97 | 44 | 0.78 |

At constant extruder speed and melt output rate, increasing the line speed does not yield a proportional reduction in the final film thickness.

The film thickness in microns is equivalent to the weight of one square meter of film in grams at a film density of 1.0 g/cm³. However, film containing 50 percent by weight calcium carbonate, and 50 percent by weight poly-lactic acid, would be expected to have a density=1/((0.5/d_{PLA})+(0.5/d_{CaCO3}))=1/((0.5/1.25)+(0.5/2.7))=1.71 g/cm³. Multiplying the calculated basis weight at 1.0 g/cm³ density times 1.71 yields the calculated basis weight for the film at the stated thickness, and a density corresponding to a solid mineral/polymer composite matrix in the film.

The actual measure basis weights for each film example are significantly lower than what is calculated for a film at the calculated density. This can only be accomplished through the presence of microscopic voids within a film generated by the combination of cooling and extensional sheer forces in a process known as cavitation.

Polypropylene and polyethylene can be used to produce cavitated films by the inclusion of a mineral such as calcium carbonate, followed by a drawing of the polymer in a solid state under controlled conditions. However, this is a two-stage process where film must be extruded, and then substantially oriented in a separate process. The present process allows the production of cavitated films in a one-step process involving both cooling and application of extensional sheer forces simultaneously in order to significantly improve production economy.

### Example 2

Blends of calcium carbonate, poly-lactic acid, and poly-butylene-adipate-terephthalate (PBAT trade name Ecoflex from BASF) were prepared with the compositions detailed in Table 2. The blends were mixed, melted, and extruded into a molten compound on a Coperion ZSK-26 twin screw compounder, and formed into pellets.

TABLE 2

| Sample ID | %5SST | % PLA | % PBAT |
|---|---|---|---|
| L014D1 | 40 | 60 | 0 |
| L014E1 | 50 | 50 | 0 |
| L014F1 | 50 | 25 | 25 |
| L014G1 | 40 | 30 | 30 |
| L014H1 | 40 | 40 | 20 |
| L014I1 | 50 | 33.3 | 16.7 |
| L014J1 | 50 | 41.7 | 8.3 |
| L014K1 | 40 | 50 | 10 |

Pellets produced from the compounding of each blend were extruded using a film casting line of the same configuration as illustrated in FIG. 3, but is fitted with a 1″ Brabender extruder 304, a six-inch slot die 306, 8-inch diameter/12-inch wide casting roll 310 and operating under the following conditions;

Extruder screw speed: 40 RPM
Barrel temperatures: Zone 1=300° F., Zone 2=320° F., Zone 3=340° F., Zone 1=340° F.
Die temperature: 340° F.

### Line Speed: 16 FPM

### Melt Pressure: 3500-4000 psi

### Chill Roll Temperature: 72° F.

The air knife 312 is adjusted so that the molten polymer curtain 308 is pressed against the chill roll 310 and polymer freezing occurs between the point of contact of the impinged air stream. Films produced under these conditions had the properties detailed in Table 3.

TABLE 3

| | Film | | Film | Compound | % Cavitation | Tensile | Young's |
|---|---|---|---|---|---|---|---|
| Sample | Thickness, | Basis Wt. | Density, | Annealed | (density | Strength, | Modulus, |
| ID | Microns | grams/M2 | g/cm3 | Density, g/cm3 | reduction) | MD, psi | MD, psl |
| L014D1 | 57.9 | 39.5 | 0.68 | 1.59 | 57.1 | 2216 | 201,980 |
| L014E1 | 65.8 | 62.1 | 0.94 | 1.71 | 44.8 | 1778 | 203,090 |
| L014F1 | 58.9 | 45.1 | 0.77 | 1.71 | 55.2 | 1260 | 98,400 |
| L014G1 | 49.2 | 36.4 | 0.74 | 1.59 | 53.5 | 1509 | 95,650 |
| L014H1 | 57.9 | 46.7 | 0.81 | 1.59 | 49.3 | 2243 | 146,860 |
| L014I1 | 61.0 | 46.7 | 0.77 | 1.71 | 55.2 | 1297 | 107,320 |
| L014J1 | 61.9 | 47.4 | 0.76 | 1.71 | 55.3 | 1395 | 125,320 |
| L014K1 | 56.4 | 40.3 | 0.72 | 1.59 | 55.0 | 1855 | 141,850 |

Film thickness was measured using a Brunswick instruments model MP-1. Base weights were determined by measuring the weight of a film sample in grams and dividing it by the sample area in square meters. Film density was calculated by dividing the measured sample basis weight by the basis weight calculated for a film at this thickness and a density of 1.0 g/cm³. The film thickness in microns is equivalent to the weight of one square meter of film in grams at film density of 1.0 g/cm³.

Using sample L014D1 as an example, at a density of 1.0 g/cm³, this film would have a basis weight equal 57.9 g/m². In fact, the actual basis weight is 39.5 g/m². This calculated to a density reduction of 57.1 percent compared to the density of the compound obtained from calculations based on raw material composition. The addition of PBAT to the calcium carbonate/PLA compound reduces the Youngs modulus (stiffness) and reduces brittleness of the extruded films.

Thus, using the above-described system and process improved film may be created having the cost effectiveness associated with the additional use of mineral compounds within the composition and the strength, weight and flexibility requirement needed for the films.

It will be appreciated by those skilled in the art having the benefit of this disclosure that this system and method for producing mineral filled polymer compounds provides a method for reducing the density of mineral/polymer compounds. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for producing a mineral/polymer compound sheet, comprising the steps of:
generating a mixture 25%-75% of a mineral with 75%-25% of a polymer;
extruding the mixture into a molten sheet of the mixture; and
processing the molten sheet of the mixture to simultaneously cool the molten sheet and create cavitation within the molten sheet to produce the mineral/polymer compound sheet defining a micro porous closed cell structure therein.

2. The method of claim 1, wherein the step of processing further includes the steps of:
cooling the molten sheet of the mixture; and
subjecting, simultaneously to the step of cooling, the cooled molten sheet of the mixture to extensional shear force to generate the mineral/polymer compound sheet defining the micro porous closed cell structure therein.

3. The method of claim 2, wherein the cooling and simultaneous subjecting of the extensional shear force increases a crystallization temperature of the mineral/polymer compound and causes rapid solidification of the molten sheet of the mixture.

4. The method of claim 2, wherein the step cooling further comprises the steps of:
applying a stream of air to the molten sheet to locate the molten sheet on a surface of a cooling roller; and
cooling the molten sheet on the surface of the cooling roller.

5. The method of claim 2, wherein the step of subjecting further comprises the steps of:
tensioning the cooled molten sheet to apply the extensional shear force; and
winding the cooled molten sheet onto a secondary roller.

6. The method of claim 1, wherein the polymer is crystalline or semi-crystalline polymer.

7. The method of claim 1, wherein the step of generating further comprises the step of including at least one moister scavenging ingredient into the mixture.

8. The method of claim 1, wherein the step of processing the molten sheet further comprises forming the cooled molten sheet into a thickness of 20 microns or less.

9. The method of claim 1, further including the step of drying the generated mixture prior to the step of extruding.

10. A flexible plastic sheet, comprising:
a mineral/polymer compound mixture including:
a mineral component comprising 25%-75% by weight of the mixture;
a polymer component comprising 75%-25% by weight of the mixture; and
wherein the flexible plastic sheet defines a micro porous closed cell structure including a plurality of microscopic voids created during a simultaneous cooling and cavitation inducing process producing the flexible plastic sheet.

11. The flexible plastic sheet of claim 10, wherein the cavitation inducing process includes continuously applying an extensional shear force to the flexible plastic sheet during cooling.

12. The flexible plastic sheet of claim 10, wherein the polymer comprises a crystalline or non-crystalline polymer.

13. The flexible plastic sheet of claim 10, wherein the mineral/polymer compound mixture further includes at least one moisture scavenging ingredient.

14. The flexible plastic sheet of claim 10, wherein the flexible plastic sheet has a thickness of 20 microns or less.

15. The flexible plastic sheet of claim 10, wherein the mineral component comprises calcium carbonate.

16. The flexible plastic sheet of claim 15, wherein the calcium carbonate has a surface area less than 4.0 m²/g.

17. The flexible plastic sheet of claim 15, wherein the calcium carbonate has a mean particle size of 2 microns to 6 microns.

18. The flexible plastic sheet of claim 15, wherein the calcium carbonate has a top size of less than 25 microns.

19. The flexible plastic sheet of claim 15, wherein a surface of the calcium carbonate has been treated with stearic acid.

20. The flexible plastic sheet of claim 10, wherein the polymer comprises poly-lactic acid or polyactide.

21. The flexible plastic sheet of claim 20, wherein the poly-lactic acid or polyactide has a melt index of 2.0-4.0 and a density of 1.25 g/cm³.

22. The flexible plastic sheet of claim 10, wherein the mineral/polymer compound mixture further includes at least one other polymer.

23. The flexible plastic sheet of claim 10, wherein the mineral/polymer compound mixture further includes at least one polyester.

24. The flexible plastic sheet of claim 10, wherein the mineral/polymer compound mixture further includes at least one of color pigments, anti-static agents, biocides, odorants, and photosensitizers.

25. The flexible plastic sheet of claim 10, wherein the mineral/polymer compound mixture further includes at least one functional additive such as peroxides or coupling agents to increase polymer molecular weight.
